(19) United States
(12) Patent Application Publication
(10) Pub. No.: US 2018/0304614 A1
(43) Pub. Date: Oct. 25, 2018

(54) METHOD FOR DISPLAYING AN ADVERTISEMENT ON A DISPOSABLE BAG

(71) Applicant: Frederic GARROY, Montclair, NJ (US)

(72) Inventor: Frederic GARROY, Montclair, NJ (US)

(21) Appl. No.: 15/491,118

(22) Filed: Apr. 19, 2017

(51) Int. Cl. B41F 17/00; B65F 1/06; B65F 1/14; B65D 33/00

(52) U.S. Cl. CPC B41F 17/006; B65D 33/004; B65F 1/14; B65F 1/06

(57) ABSTRACT

A method of providing an indicia, such as an advertisement, on the interior of a disposable bag, e.g., a trash or garbage bag, such that when the disposable bag is inserted into a receptacle, e.g., a trash can, and folded over, the indicia becomes visible at exterior side of the receptacle for perception by a viewer.

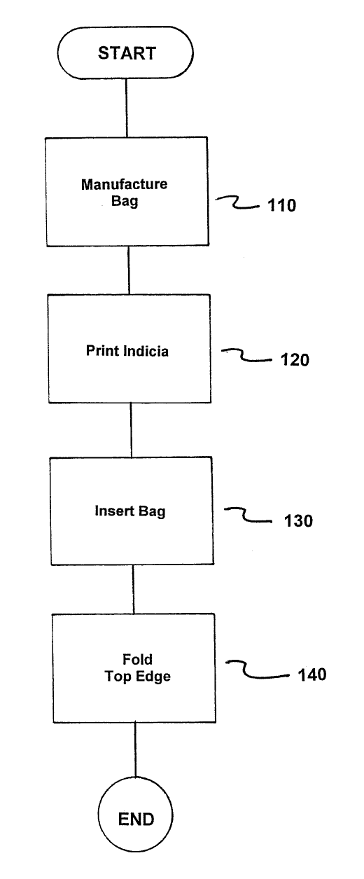

### BACKGROUND OF THE INVENTION

### 1. Field of the Invention

The present invention relates to media advertising and, more particularly, to a method for displaying an advertisement on a disposable bag, such as a trash or garbage bag, for presentation to a viewer.

### 2. Description of the Related Art

In general, the use of a trash bag is well settled, i.e., for receiving refuse or garbage. However, the implementation of a trash bags beyond merely receiving garbage has become commonplace.

For example, trash bags have been used as a pressure bandage or a triangle bandage. It is also known to use such bags to cover a traditional bandage to help protect a wound from exposure to dirt or the bandage from exposure to the rain. Another use is, for example, is to tie a splint with a trash bag, double the bag or tape two together to make a sturdier splint.

The following are additional exemplary uses of a trash bag. When the clothes of a college student, for example, become so disgusting that they cannot stand them anymore, and they just stuff them all in a garbage bag and make the trek back home to have mom or dad do their laundry.

Trash or garbage bags are often used as make do luggage when a person, for example, is planning on going somewhere, but don't have any luggage and either don't have time or money to purchase any, and a garbage bag thus serves this purpose.

Another us of trash or garbage bags is as a temporary backpack. While this use is somewhat related to the make do luggage, this use requires a trash or garbage bag with a drawstring.

Trash or garbage bags have also been used to collect rainwater. Here, the bag is merely spread out while it is raining, the water gather and is then ready for use. Naturally, with the understanding that a trash or garbage bag can be used to collect water it understandable that they may also be used to store water. Other uses are: a laundry basket, forage collection, grocery bag, short-term food storage, hanging food in a tree, emergency poncho, keeping feet dry, and ground cover.

### SUMMARY OF THE INVENTION

Disclosed is a method for displaying an advertisement on a disposable bag, such as a trash or garbage bag.

In accordance with the method of the invention, the disposable bag is manufactured in accordance with known methodologies. For example, disposable bags are created in large plants using heavy machinery. These disposable bag are created in long tubes, then cut and separated to produce individual bags.

Trash bags are made from polyethylene—a tough, light, flexible plastic used chiefly in containers, insulation, and packaging. Polyethylene is a polymer (a type of chemical compound) of ethylene, a colorless gas used in the production of many chemicals. Polyethylene is resistant to chemicals and moisture, and has good insulating properties.

Resin pellets are small, hard cylindrical shaped plastic particles. To make disposable bags, such as the trash or garbage bags, in accordance with the invention polyethylene resin pellets are poured into large hoppers, or containers used for pouring materials into a machine or opening.

The resin pellets then enter an extruder, which is a machine that melts the pellets by heating them to a temperature between 365 and 465 degrees Fahrenheit. Once the pellets are heated and thoroughly mixed by the extruder the remaining raw plastic mixture is then pushed through a die. A die, or a special tool to cut or shape material, forms the plastic into a ring. The ring is then blown into a bubble. It is at this stage that an indicia can first be placed on the interior of the disposable bag, such as the trash or garbage. The indicia is the actual advertisement that is provided for viewing.

At this stage, the plastic tube gradually cools down, is several hundred feet long, and has a minimum thickness. In certain embodiments, the minimum thickness is two ten-thousands of an inch.

Next, rollers collapse the bubble into a flat tube, called a film, which is easy to work with. The film is then cut to a desired width, where extra film is salvaged in a tube, and where the tube of flattened film is heat-sealed on one side. The film is perforated, then cut into bags.

Next, the disposable bags are then folded, stacked, and inserted into their packaging, ready for use. In use the bag is inserted into an open receptacle. This receptacle typically has a circumferential, upper, open end, with the shape of the opening being formed to merely permit inserting on the bag in the receptacle, which is typically a garbage can or some other trash receptacle.

Next, the disposable bag is folded over the upper, open end of the receptacle. With this last step, the indicia placed on the interior of the disposable bag becomes exposed to the exterior of the open receptacle for perception by a view or person.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The FIGURE is a flowchart of the method in accordance with the invention.

### DETAILED DESCRIPTION OF THE EXEMPLARY EMBODIMENTS

The drawing is a flowchart of a method for displaying an advertisement on a disposable bag, such as a trash or garbage bag.

In accordance with the method of the invention, the disposable bag is manufactured, as indicated in step 110. For example, it is known to create disposable bags in large plants using heavy machinery. These disposable bags are created in long tubes, then cut and separated to produce individual bags.

It is also know to manufacture trash bags from polyethylene—a tough, light, flexible plastic used chiefly in containers, insulation, and packaging. Polyethylene is a polymer (a type of chemical compound) of ethylene, a colorless gas used in the production of many chemicals. Polyethylene is resistant to chemicals and moisture, and has good insulating properties.

Resin pellets are small, hard cylindrical shaped plastic particles. To make disposable bags, such as the trash or garbage bags, in accordance with the invention polyethylene resin pellets are poured into large hoppers, or containers used for pouring materials into a machine or opening.

The resin pellets then enter an extruder, which is a machine that melts the pellets by heating them to a temperature between 365 and 465 degrees Fahrenheit. Once the pellets are heated and thoroughly mixed by the extruder the remaining raw plastic mixture is then pushed through a die. A die, or a special tool to cut or shape material, forms the plastic into a ring. The ring is then blown into a bubble.

Next, an indicia is placed on the interior of the disposable bag, as indicated in step 120. Here, the indicia is the actual advertisement that is provided for viewing. In preferred embodiments, the indicia is placed inverted with respect to the open end of the disposable bag, i.e., the top of the indicia is oriented toward the bottom of the disposable bag.

At this stage, the plastic tube gradually cools down, is several hundred feet long, and has a minimum thickness. In certain embodiments, the minimum thickness is two ten-thousands of an inch. In alternative embodiments, it is at this stage that the indicia is placed in the interior of the disposable bag.

Next, rollers collapse the bubble into a flat tube, called a film, which is easy to work with. The film is then cut to a desired width, where extra film is salvaged in a tube, and where the tube of flattened film is heat-sealed on one side. The film is perforated, then cut into bags.

Next, the disposable bags are then folded, stacked, and inserted into their packaging, ready for use. In use the bag is inserted into an open receptacle, as indicated in step 130. This receptacle typically has a circumferential, upper, open end, with the shape of the opening being formed to merely permit inserting on the bag in the receptacle, which is typically a garbage can or some other trash receptacle.

Next, the disposable bag is folded over the upper, open end of the receptacle, as indicated in step 140. In accordance with the disclosed embodiments of the invention, the indicia placed on the interior of the disposable bag becomes exposed to the exterior of the open receptacle for perception by a viewer or person.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of displaying an indicia on a disposable bag, comprising:
manufacturing the bag;
printing an indicia in an interior of the disposable bag; said indicia being printed inverted with respect to an open circumferential end of the disposable bag;
inserting the disposable bag into an open receptacle; and
folding a top edge of the disposable bag over the open circumferential bag such that the indicia printed inverted is displayed on an exterior side of the receptacle.

2. The method of claim 1, wherein the indicia is an advertisement

3. The method of claim 1, wherein the indicia is displayed in an upper portion of the receptacle.

4. The method of claim 1, wherein the indicia is displayed in an upper one third of the receptacle.

5. The method of claim 1, wherein the receptacle is a garbage can.

6. The method of claim 1, wherein the disposable bag is a trash bag or garbage bag.

7. The method of claim 1, wherein the indicia is printed inverted within an upper half of the disposable bag.
